(19) United States
(12) Patent Application Publication
(10) Pub. No.: US 2014/0090567 A1
(43) Pub. Date: Apr. 3, 2014

(54) T-MOLDING ROLLER

(71) Applicant: Crain Cutter Co., Inc., Milpitas, CA (US)

(72) Inventors: Daniel D. Haas, Gympie (AU); Tan D. Nguyen, Milpitas, CA (US); Greg Chambers, Morgan Hill, CA (US)

(73) Assignee: Crain Cutter Co., Inc., Milpitas, CA (US)

(21) Appl. No.: 14/028,766

(22) Filed: Sep. 17, 2013

(30) Foreign Application Priority Data
Sep. 19, 2012 (AU) 2012904081

(51) Int. Cl. E04F 21/00; B30B 9/00

(52) U.S. Cl. CPC E04F 21/0053; B30B 9/00
USPC 100/35; 100/100

(57) ABSTRACT

A roller tool for installing T-molding is provided. The roller tool is configured to receive the T-molding into a front of the body. The T-molding has a top surface and a bottom surface, with an insert of the T-molding extending from the bottom surface of the T-molding. The roller tool includes a guidance member attached to the body, the guidance member configured to align the body to a channel. One or more T-molding guide surfaces, slidably contacting the T-molding insert, guide the T-molding over the guidance member and the channel. The roller tool includes a pressure roller, rotatably attached to the body, the pressure roller positioned rearward of the front of the body, the pressure roller configured to press on the top surface of the T-molding so that, with the front of the body moving forward, the insert of the T-molding is pressed into the channel by the pressure roller.

This application claims benefit of priority from Australian Provisional Application No. 2012904081 filed Sep. 19, 2012, which is hereby incorporated by reference for all purposes.

### BACKGROUND

In the floor covering trade, flooring installers often have a need to create transitions between different types of floor coverings. For example, in one area of a given room, an area of vinyl composition tile (“VCT tile”) that is to be installed might transition to another area in which carpet is to be installed. In such case, the two materials are installed up to a transition material, and the transition material covers a gap that might otherwise exist between the materials. The transition protects the edges of the floor covering materials and prevents debris build-up between them.

One type of transition material is T-molding, sometimes referred to as “capping” in areas of the world such as Australia. In floor covering applications, T-molding is a flexible strip transition material typically made from extruded rubber or vinyl. T-molding is so-called because it has a T-shaped cross-section. The top of the “T” faces upward from the floor, and an insert of the T-molding, corresponding to the stem of the “T”, is downward upon installation. The T-molding is installed in conjunction with track material usually made from extruded aluminum. The track is fastened to a subfloor, for example by gluing or nailing. The track includes a channel, into which the insert of the T-molding is forced. A commonly used technique for installing T-molding is to hammer or mallet on the top surface of the T-molding while manually aligning the insert of the T-molding to the channel. Various types of hammers or mallets can be used.

A rubber mallet is used when malleting the T-molding to protect the top surface of the T-molding from being scratched or scuffed, as well as to protect the adjacent floor covering materials. T-molding is soft and easily scratched or scuffed. Any tile or sheet vinyl that is installed at the transition is also easily scratched, scuffed, or chipped. Any such damage to these materials can result in an unacceptable installation.

The process of snapping the T-molding into the track using a rubber mallet can be time-consuming and laborious, particularly on long lengths that are frequently encountered in commercial installations. Only about 4 inches of the T-molding can be malleted at a time, and each section requires several blows. The malleting must also be done from an uncomfortable kneeling position.

Tools from other trades that are used to quickly install T-molding, such as rapid fire pneumatic impact hammers, or roller-fed process machinery, are not practical for use on a floor covering jobsite. Flooring installers often do not own an air compressor required for pneumatic equipment. The available process machinery is designed for factory installation of T-molding onto the edges of tables, window frames, or automotive assemblies. The guidance mechanisms on such process machinery may not be adaptable to the installation of flooring T-molding and track.

Furthermore, T-molding for flooring applications is produced in various profiles for transitions between many different types of flooring materials. For example, the top surface of the T-molding can be provided in varying widths. The insert itself can be provided in different heights to accommodate thinner or thicker floor coverings. The insert may also be located off-center in relation to the overall width of the top surface of the T-molding. Furthermore, one side of the top surface can extend further downward than the other.

Previously used tools for installing T-molding may not be adaptable to all these various profiles of T-molding for flooring applications, particularly those T-moldings with an off-center insert or a top surface with one side extending downward further than the other. Previously used tools for installing T-molding have also not included a means to prevent the tool from contacting floor coverings adjacent to the transition to prevent the floor coverings from being scratched or scuffed. What is needed is a simple and inexpensive hand tool that can rapidly insert the various kinds of T-molding for floor covering applications into the track material, without scratching or scuffing the T-molding, and without contacting the adjacent floor coverings. Therefore, there is a need in the art for a solution which overcomes the drawbacks described above.

### SUMMARY

A roller tool for installing T-molding is provided in some embodiments. The roller tool includes a body, one or more T-molding guide surfaces that guide the T-molding into the front of the body, a guidance member, and a pressure roller. The T-molding has a top surface, a bottom surface, and an insert extending from the bottom surface. The T-molding is inserted into the channel of the track material. The T-molding is guided into the body by the one or more T-molding guide surfaces contacting the insert of the T-molding. The guidance member is inserted into the channel of the track. The relative positioning of the one or more T-molding guide surfaces to the guidance member locates the T-molding over the channel. The pressure roller is rotatably attached to the body rearward of the front of the body. The pressure roller is configured to press on the top of the T-molding so that, with the front of the body moving in a forward direction, the insert of the T-molding is pressed into the channel by the pressure roller.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a cross-section view of an example of T-molding and an example of a track with a channel.

FIG. 2 is a cross-section view of a finished T-molding transition.

FIG. 3 is a perspective view of a T-molding roller.

FIG. 4 is an exploded view of the T-molding roller of FIG. 3.

FIG. 5 is a front end view of the T-molding roller of FIGS. 3-5, showing T-molding being installed.

FIG. 6 is a side view of the T-molding roller of FIGS. 3-5, showing T-molding being installed.

FIG. 7 is a cross-section view of a further example of T-molding.

FIG. 8 is a flow diagram of a method for installing T-molding.

### DETAILED DESCRIPTION

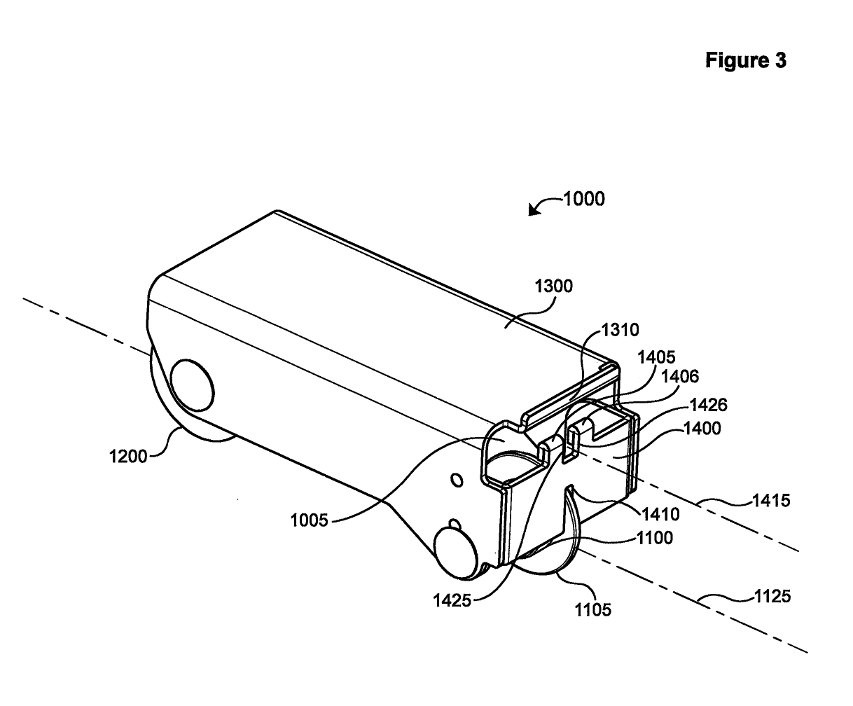

A roller tool, as disclosed herein, includes embodiments of a flooring T-molding roller tool as shown in FIGS. 3-6 and 8. Embodiments of the roller tool are used for installing T-molding into a channel. Particularly, embodiments shown as a flooring T-molding roller are used for installing T-molding into a channel, such as the channel of a track material being used to form a transition between two floor covering materials. The roller tool has a body, one or more T-molding guide surfaces, a guidance member, and a pressure roller. The roller tool operates by guiding the T-molding into the body by way of the T-molding guide surfaces. The guidance member is inserted into the channel of the track. The relative position of the T-molding guide surfaces to the guidance member positions the T-molding over the channel of the track. The relative position of the pressure roller to the guidance member positions the pressure roller over the channel of the track so that the pressure roller is in position to press the insert of the T-molding into the track. Embodiments of the roller tool are hammerless, in that the pressure roller and other mechanisms included in the roller tool do not have a hammer, or a hammer head, and instead rely on rolling to perform the various functions of the roller tool.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

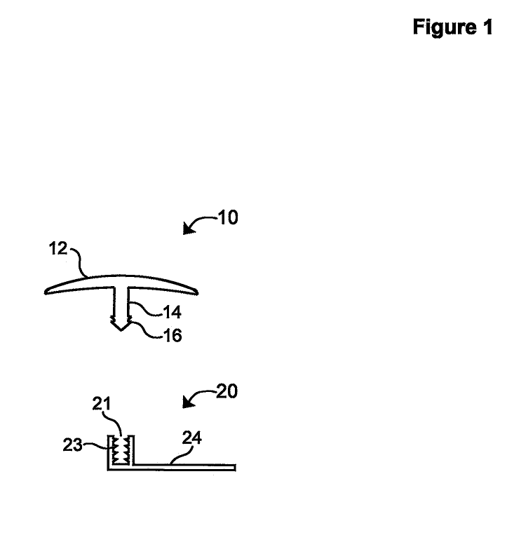

An example of T-molding and the track used to fasten the T-molding to a subfloor, is shown in FIG. 1. T-molding 10 has a top surface 12, and an insert 14 extending from a bottom surface of the T-molding. Insert 14 has barbs 16.

To install this transition, track 20 is fastened to a subfloor as by gluing or nailing. The track 20 has a channel 21 with teeth 23 and a flat 24. The insert 14 of T-molding 10 is “snapped” or pressed into channel 21 of track 20 by applying an embodiment of the disclosed roller tool to the top surface 12 of T-molding 10. Teeth 23 of track 20 hold barbs 16 of T-molding 10, preventing T-molding 10 from being easily removed.

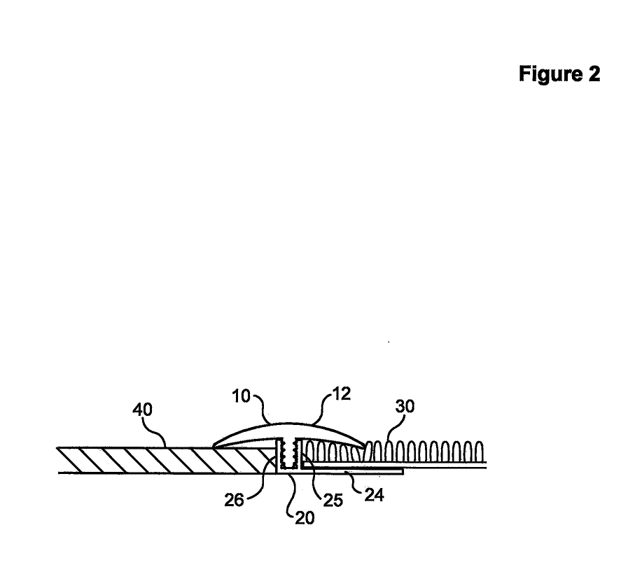

A finished T-molding transition is shown in FIG. 2. Carpet 30 is installed up to track 20 on top of flat 24, all the way up to right outer edge 25. VCT tile 40 is installed up to left outer edge 26 of track 20. T-molding 10 is snapped into track 20. Top surface 12 of T-molding 10 covers the transition between carpet 30 and VCT tile 40.

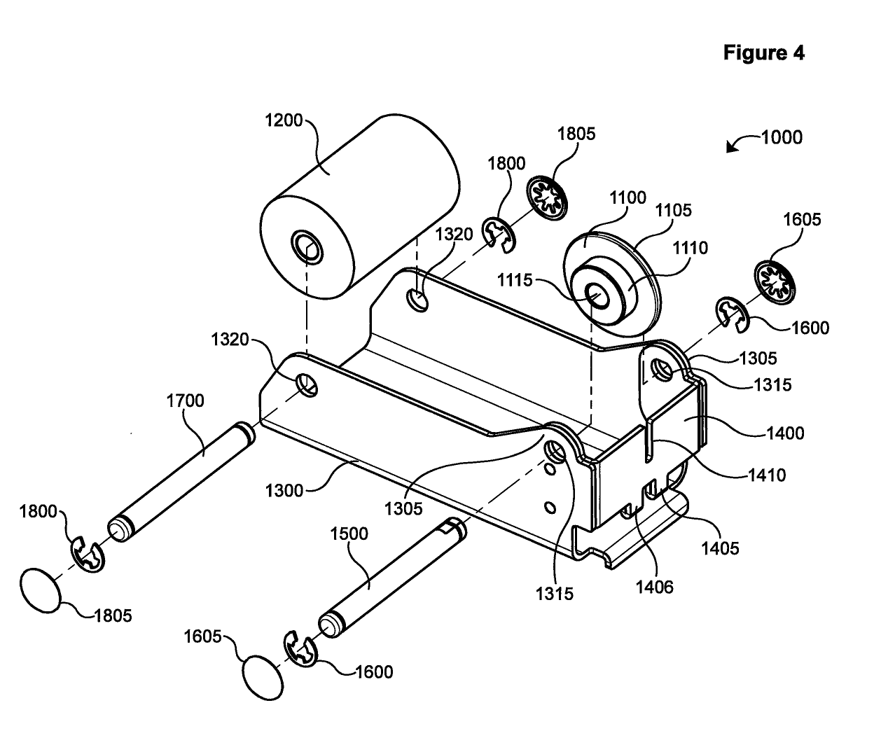

As shown in FIG. 3, T-molding roller 1000 includes guide wheel 1100, pressure roller 1200, body 1300, and guide plate 1400. FIG. 4 shows T-molding roller 1000 in an upside-down exploded view. Guide wheel 1100 has a thin, large-diameter guidance edge 1105 which defines an outer circumference extending from a smaller-diameter flanged surface 1110. As will be discussed below with regard to usage of the tool, guidance edge 1105 is thin enough to enter the narrow track channel. As will also be discussed below, guidance edge 1105 defines a sufficiently large diameter to raise body 1300 above adjacent transition floor covering materials, preventing scratching or scuffing by the tool itself in use. FIG. 3 shows that guide wheel 1100 (and guidance edge 1105) have a guide wheel centerline 1125.

As shown in FIG. 3, guide plate 1400 has guide wheel slot 1410 which positions guidance edge 1105 of guide wheel 1100. Guide plate 1400 also has a left insert guide 1405 and a right insert guide 1406. Left insert guide 1405 has a left insert guide edge 1425. Right insert guide 1406 has a right insert guide edge 1426. The horizontal centerline between left insert guide edge 1425 and right insert guide edge 1426 will be referred to as guide edge centerline 1415.

Guide wheel centerline 1125 is a horizontal line on the same vertical plane as guide edge centerline 1415. The way this is achieved as follows: The guide edge centerline 1415 is a horizontal line passing midway between left insert guide edge 1425 and right insert guide edge 1426. Guide wheel slot 1410 of guide plate 1400 is centered horizontally on the same vertical plane as guide edge centerline 1415. As a result, when guidance edge 1105 of guide wheel 1100 is inserted into guide wheel slot 1410 of guide plate 1400, guide wheel centerline 1125 is also centered horizontally on the same vertical plane as guide edge centerline 1415. Therefore, when guidance edge 1105 of guide wheel 1100 is inserted and centers within the channel of a track, guide wheel slot 1410 ensures that the centerline of the track channel, the guide wheel centerline 1125, and the guide edge centerline 1415 will all be centered horizontally on the same vertical plane. As used herein, guide wheel 1100 is an example of a guidance member that is insertable into the channel of the track to guide the roller tool along the channel of the track as it is moved forward along the track. A person skilled in the art might envision other similar means of guiding the roller tool, including a simple fm or extension of the body 1300 or guide plate 1400 that is insertable into the track channel to guide the roller tool. Any such is included in the definition of a guidance member.

Left insert guide edge 1425 and right insert guide edge 1426 are both equally spaced from guide edge centerline 1415. The total space between left insert guide edge 1425 and right insert guide edge 1426 accepts the width dimension of the insert of the T-molding. The height of left insert guide edge 1425 and right insert guide edge 1426 accommodates the height dimension of the insert 14 of the T-molding 10. Left insert guide edge 1425 and right insert guide edge 1426 guide the insert 14 of T-molding 10 over guide wheel centerline 1125, as well as over the channel of the track. From this position, the T-molding 10 will easily pass through body 1300 to pressure roller 1200 where it is pressed into the track channel. As used herein, left insert guide edge 1425 and right insert guide edge are T-molding guide surfaces which guide the T-molding 10 by contacting the insert 14 (shown in FIG. 1) of the T-molding 10.

As shown in FIG. 3, body 1300 includes a lip 1310 which holds the T-molding down so that the insert of the T-molding stays between left insert guide edge 1425 and right insert guide edge 1426 as the T-molding enters body 1300. In one embodiment, the lip 1310 slidably presses on the top surface 12 (FIG. 1) of the T-molding 10 (FIG. 1) such that the insert 14 (FIG. 1) slidably engages the left insert guide edge 1425 and right insert guide edge 1426. Lip 1310 provides a smooth surface pressing insert 14 (FIG. 1) back between left insert guide edge 1425 and right insert guide edge 1426 should the T-molding 10 (FIG. 1) start to rise up out from between left insert guide edge 1425 and right insert guide edge 1426. This could happen if the T-molding roller 1000 were moved too rapidly down the track channel, or if the T-molding 10 (FIG. 1) were somehow bent or turned as it approached left insert guide edge 1425 and right insert guide edge 1426.

As shown in FIG. 4, body 1300 includes arms 1305. Formed in arms 1305 are guide wheel bearing holes 1315 which accept guide wheel axle 1500. To install guide wheel 1100, guidance edge 1105 is inserted into guide wheel slot 1410 of guide plate 1400. Guide wheel axle 1500 is inserted through a guide wheel bearing hole 1315, through guide wheel hole 1115, and through another guide wheel bearing hole 1315. Guide wheel axle 1500 is fastened by e-clips 1600 and caps 1605.

To install pressure roller 1200, the pressure roller 1200 is inserted into body 1300 and aligned with pressure roller bearing holes 1320. Pressure roller axle 1700 is inserted through a pressure roller bearing hole 1320, through pressure roller 1200, and through another pressure roller bearing hole 1320. Pressure roller axle 1700 is fastened by e-clips 1800 and caps 1805.

In one embodiment, the pressure roller 1200 is essentially cylindrical or has a center section that is cylindrical, i.e., a cylinder of constant diameter. In a further embodiment, the pressure roller 1200 is convex or has a center section that is convex, which concentrates pressure on the portion of the top surface 12 (FIG. 1) of the T-molding 10 that most effectively transfers force to pressure the T-molding insert 14 (FIG. 1) into the track channel. In still a further embodiment, the pressure roller 1200 is concave, which maximizes contact area where the pressure roller 1200 contacts the top surface 12 (FIG. 1) of the T-molding 10 (FIG. 1). A concave pressure roller 1200 could more evenly spread loads from the pressure roller 1200 to the top surface 12 (FIG. 1) of the T-molding 10 (FIG. 1), but might not conform exactly to the all available shapes of all T-molding top surfaces 12 (FIG. 1), which could result in scuffing or scratching of some T-molding top surfaces 12 (FIG. 1).

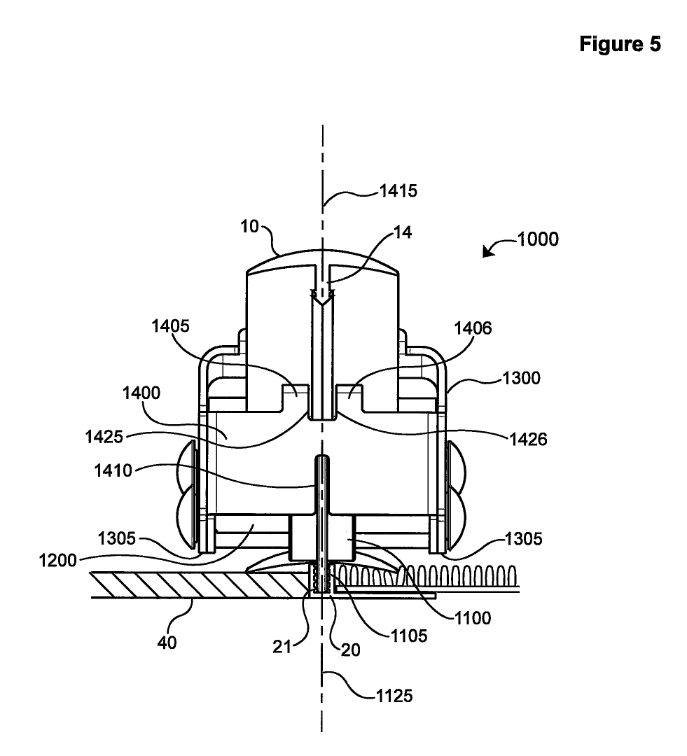

FIG. 5 shows T-molding roller 1000 in use at a flooring transition. T-molding 10 is being fed into the T-molding roller 1000 from in front of the T-molding roller 1000. Guidance edge 1105 of guide wheel 1100 is thin enough to be inserted into the channel 21 of track 20. Guidance edge 1105 defines a diameter large enough to raise even the lowest point of body 1300 at arms 1305 above VCT tile 40. This prevents VCT tile 40 from being scratched or scuffed by body 1300. In some embodiments, the guidance member (e.g., the guide wheel 1100 in one embodiment) and the pressure roller 1200 support the body 1300 such that a separation distance is maintained between the body 1300 and a floor covering while the pressure roller 1200 presses the T-molding 10 along an edge of the floor covering. Dimensions can be adjusted, in various embodiments, for various separation distances and various floor coverings.

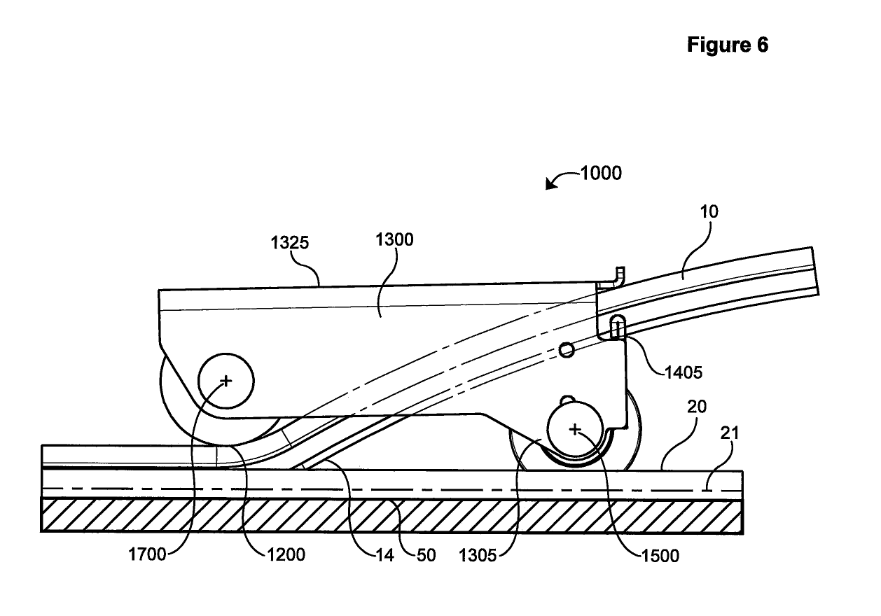

As shown in FIG. 6, arms 1305 of body 1300 position the axis defined by guide wheel axle 1500 at a lower elevation than the axis defined by pressure roller axle 1700. This vertical offset between the axis of guide wheel axle 1500 and the axis of pressure roller axle 1700 provides clearance beneath pressure roller 1200 for T-molding 10. FIG. 6 shows T-molding 10 beneath pressure roller 1200 at the point where the insert 14 of the T-molding 10 is to be pressured or pressed into the track 20. In the embodiment shown, the T-molding 10 enters at a front of the T-molding roller tool 1000, passes through the body 1300, and is pressed into the channel 21 of the track 20 at the pressure roller 1200 located at the back of the T-molding roller tool 1000.

The vertical offset between the axis of guide wheel axle 1500 and the axis of pressure roller axle 1700 positions all or a majority of the top surface 1325 of body 1300 roughly parallel with a subfloor surface 50, or parallel to the channel 21 of the track 20. This creates an ergonomic location at top surface 1325 for hand pressure.

The horizontal offset between the axis of guide wheel axle 1500 and the axis of pressure roller axle 1700 permits a gradual transition of T-molding 10 from a starting height at the left insert guide 1405 to the bottom of pressure roller 1200 where it is pressed into the track. Body 1300 is hollow internally and with no features having edges that could scratch T-molding 10 as it passes through to pressure roller 1200.

Returning to FIG. 5, guide plate 1400 has guide wheel slot 1410 which centers guide wheel centerline 1125 of guidance edge 1105 of guide wheel 1100 horizontally on the same vertical plane as guide edge centerline 1415 between left insert guide edge 1425 and right insert guide edge 1426. Left insert guide edge 1425 and right insert guide edge 1426 are equally spaced from guide edge centerline 1415. Thus, when guidance edge 1105 of guide wheel 1100 is inserted into the channel 21 of a track 20, and the insert 14 of T-molding 10 is inserted between left insert guide edge 1425 and right insert guide edge 1426, the T-molding insert should be centered horizontally on the centerline of the channel of the track. This ensures that the insert of T-molding will be centered horizontally over the channel of the track as it passes through body 1300 to pressure roller 1200.

Because the T-molding may be produced in varying widths of top surfaces, some having one side of the top surface extending downward further than the other, some having inserts of differing heights, or some even having inserts that are off-center, it is preferred to guide the T-molding through the tool by using the insert of the T-molding. Additionally it is preferred to guide the T-molding by contacting the insert only so that there is no risk of scratching or scuffing the top surface 12 (FIG. 1) of the T-molding 10 (FIG. 1). The insert is the feature that all these T-molding profiles having in common. FIG. 5 shows a T-molding 10 is being guided by the insertion of the insert 14 of the T-molding 10 between left insert guide edge 1425 and right insert guide edge 1426.

Returning to FIG. 3, opening 1005 of T-molding roller 1000 is sufficiently wide to accommodate a variety of different widths of T-molding. The space between the lip 1310, of body 1300, and the top surfaces of left insert guide 1405 and right insert guide 1406 provides sufficient clearance for T-moldings with inserts of varying heights. This space provides that a range of heights of T-molding insert can be inserted between left insert guide edge 1425 and right insert guide edge 1426 for guidance.

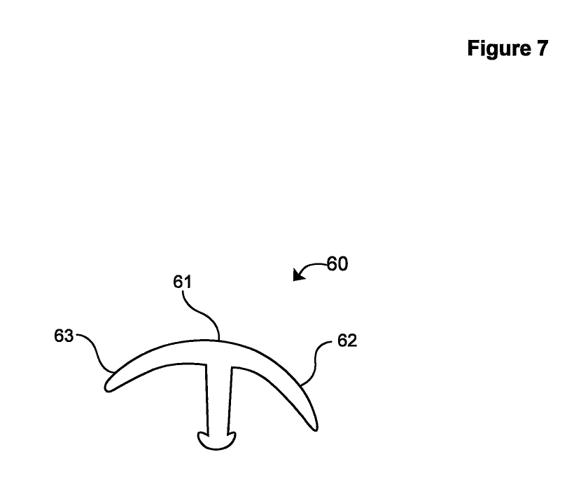

100441 As shown in FIG. 7, a T-molding 60 has a top surface 61 with a right side 62 which extends downward further than left side 63. With this type of T-molding, a thick floor covering such as carpet can be installed beneath left side 63 of T-molding 60, while a thin floor covering such as sheet vinyl can be installed on right side 62. Without any necessary adjustment, the T-molding roller 1000 of FIGS. 3-7 is capable of accommodating asymmetrical T-molding like T-molding 60 of FIG. 12, or symmetrical T-molding like T-molding 10 of FIG. 1. Moreover, various widths of either variety of T-molding could also be accommodated, because guidance of the T-molding is by the insert 14 (FIG. 1), which is common to most T-molding profiles.

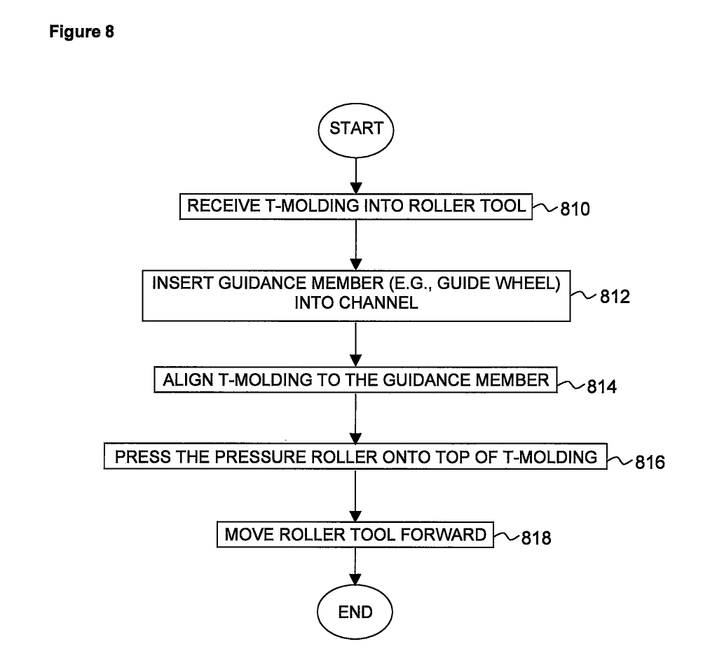

A method for installing T-molding is shown in FIG. 8. The method, and variations thereof, can be practiced using embodiments of the roller tool, and particularly using embodiments of the T-molding roller. The roller tool and the T-molding roller are types of roller tools.

In an action 810, T-molding is received into a roller tool. For example, the T-molding can be received into the body of the roller tool. In one embodiment, the T-molding passes into the body forward of the pressure roller of the roller tool.

In an action 812, a guidance member is inserted into a channel. For example, a guide wheel could be used as a guidance member, with the guide wheel inserted into the channel of a track into which the T-molding is to be installed. In one embodiment, the guide wheel is dimensioned so as to fit in the channel of the track and align the body and the T-molding guide surfaces of the roller tool, while further aligning the pressure roller to the channel, centering the pressure roller over the channel.

In an action 814, the T-molding is aligned to the guidance member of the roller tool. For example, the T-molding can be aligned to the guidance member of the roller tool via application of one or more T-molding guide surfaces, as discussed above.

In an action 816, the pressure roller is pressed onto the top of the T-molding. In an action 818, the roller tool is moved forward, i.e., the body of the roller tool is moved in a forward direction. Pressing the pressure roller onto the top surface of the T-molding and moving the roller tool forward results in the insert of the T-molding being inserted into the channel and the insert seating to the channel.

In one embodiment of the method, the insert of the T-molding passes between the left insert guide and the right insert guide. Surfaces of the left insert guide and the right insert guide are included in the guide surfaces. The left insert guide and the right insert guide are attached to the body forward of the pressure roller, in one embodiment of the roller tool.

In one embodiment of the method, the T-molding passes into the body of the roller tool at a front of the body. The guide surfaces include a third surface that presses on the top surface of the T-molding so that the insert of the T-molding passes between a first surface and a second surface. The first surface and the second surface are included in the guide surfaces.

In one embodiment of the method, the T-molding enters the body forward of the pressure roller. The T-molding enters the body of the roller tool rearward of the guide surface or surfaces. The T-molding exits the body and is pressed by the pressure roller as the body moves in a forward direction.

It should be appreciated that embodiments of the roller tool can install types of T-molding in applications besides flooring. For example, embodiments of as the roller tool could install T-molding on edges of furniture such as desks, or on edges of wall partitions and in other locations.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

As previously explained, T-molding is sometimes referred to as “capping” in some areas of the world, such as Australia. As used herein, the terms capping roller, T-molding roller, and roller tool (as shown in FIGS. 3-8) all have the same meaning, and can all be used interchangeably.

What is claimed is:

1. A roller tool for inserting T-molding into a channel, the T-molding having a top surface, a bottom surface, and an insert extending from the bottom surface, comprising:
a body including a body top surface;
a guidance member insertable into the channel, the guidance member positioned at a forward area of the roller tool; and
a pressure roller positioned rearward of the guidance member, the pressure roller configured to press on at least a portion of the top surface of the T-molding above the T-molding insert;
wherein with the guidance member inserted in the channel, and with the T-molding entering the roller tool with at least a portion of the T-molding passing above the guidance member, and with the roller tool moving in a forward direction, the roller tool is configured to guide the T-molding insert over the channel and to have the T-molding insert pressed into the channel by the pressure roller.

2. The roller tool of claim 1, wherein the roller tool is hammerless.

3. The roller tool of claim 1, wherein the pressure roller includes a section that is one of convex or uniformly cylindrical.

4. The roller tool of claim 1, wherein the guidance member includes a guide wheel configured to fit into the channel.

5. The roller tool of claim 1, wherein the guidance member and the pressure roller support the body such that a separation distance is maintained between the body and a floor covering while the pressure roller presses the T-molding into the channel.

6. The roller tool of claim 1, further comprising:
one or more T-molding guide surfaces, the one or more T-molding guide surfaces guiding the T-molding over the channel by slidable contact between the insert of the T-molding and the one or more T-molding guide surfaces.

7. The roller tool of claim 1, wherein with the guidance member inserted into the channel, and the pressure roller pressing the insert of the T-molding into the channel, the guidance member and the pressure roller support the body such that a majority of the body top surface is substantially parallel with a flat bottom of the channel

8. The roller tool of claim 1, further comprising:
a first surface, a second surface and a third surface, each forward of the pressure roller;
wherein:
the first surface and the second surface are T-molding guide surfaces; and
the third surface is configured to slidably press on the top surface of the T-molding such that the insert of the T-molding slidably passes between the first surface and the second surface.

9. A roller tool to insert a T-molding into a track to form a transition between two adjacent floor coverings, comprising:
a body including a body top surface;
a guidance member insertable into a channel of the track for guiding the roller tool as the roller tool is moved along the track;
one or more T-molding guide surfaces arranged to contact a T-molding insert of the T-molding; and
a pressure roller positioned rearward of the one or more T-molding guide surfaces, the pressure roller including a surface that presses the T-molding insert into the channel of the track;
wherein as the roller tool is moved in a forward direction along the track, the one or more T-molding guide surfaces position the T-molding insert over the channel of the track; and
wherein the body is positioned at a non-zero height above an adjacent floor covering surface.

10. The roller tool of claim 9, wherein the guidance member includes a wheel that has a guidance edge insertable into the channel of the track.

11. The roller tool of claim 10, wherein the guidance member and the pressure roller support the body such that a separation distance is maintained between the body and a floor covering while the pressure roller presses the T-molding into the channel.

12. The roller tool of claim 9, wherein the one or more T-molding guide surfaces includes two T-molding guide surfaces spaced apart such that the T-molding insert is insertable between them.

13. The roller tool of claim 9, wherein:
the one or more T-molding guide surfaces includes two T-molding guide surfaces; and
when the guidance member is inserted into the channel of the track, and the T-molding insert is inserted between the two T-molding guide surfaces, the T-molding insert is positioned over the channel of the track.

14. The roller tool of claim 9, further comprising:
a lip surface, wherein:
the lip surface is configured to contact a top surface of the T-molding and keep the T-molding insert in contact with a one or more T-molding guide surfaces.

15. The roller tool of claim 9, wherein the T-molding enters at a front of the roller tool, passes through the body, and is pressed into the channel of the track at the pressure roller located at a back of the roller tool.

16. The roller tool of claim 9, wherein the pressure roller has an outer surface that presses the T-molding, the outer surface essentially a cylinder of a constant diameter.

17. A method for installing T-molding, comprising:
receiving the T-molding into a body of a roller tool wherein the T-molding passes into the body forward of a pressure roller of the roller tool;
inserting a guidance member into a channel, the guidance member forward of the pressure roller;
aligning the T-molding to the guidance member via application of at least one T-molding guide surface;
pressing the pressure roller onto a top surface of the T-molding; and
moving the body in a forward direction along the channel, wherein an insert of the T-molding, extending from a bottom surface of the T-molding, is inserted into the channel as a result of pressing the pressure roller onto the top surface of the T-molding and moving the body in the forward direction along the channel.

18. The method of claim 17, wherein receiving the T-molding into the body of the roller tool and aligning the T-molding to the guidance member includes:
passing the insert of the T-molding between a left T-molding guide surface and a right T-molding guide surface, wherein the at least one T-molding guide surface includes surfaces of the left T-molding guide surface and the right T-molding guide surface, and wherein the left T-molding guide surface and the right T-molding guide surface are attached at a forward area of the body and forward of the pressure roller.

19. The method of claim 17, wherein:
the T-molding passes into the body at a forward area of the body;
the at least one T-molding guide surface includes a first T-molding guide surface contacting the insert of the T-molding, a second T-molding guide surface contacting the insert of the T-molding, and a third surface;
the third surface presses on the top surface of the T-molding so that the insert of the T-molding passes between the first T-molding guide surface and the second T-molding guide surface.

20. The method of claim 17, wherein the T-molding enters the body forward of the pressure roller and rearward of the at least one guide surface as the body moves in the forward direction.
